(19) United States
(12) Patent Application Publication
(10) Pub. No.: US 2025/0378562 A1
(43) Pub. Date: Dec. 11, 2025

(54) METHOD AND DEVICE FOR VIDEO SEMANTIC SEGMENTATION PIPELINE FOR CONTENT-AWARE IMAGE SIGNAL PROCESSING

(71) Applicant: Samsung Electronics Co., Ltd., Gyeonggi-do (KR)

(72) Inventors: Rama Mythili VADALI, Vista, CA (US); Burhan Ahmad MUDASSAR, San Diego, CA (US); Prithvi SURESH, San Diego, CA (US); Hai SU, San Diego, CA (US); Nagaraja SHIVASHANKAR, San Diego, CA (US); Oleg KHORUZHIY, San Diego, CA (US); Varun PAWAR, San Diego, CA (US); Mostafa EL-KHAMY, San Diego, CA (US); Minyeong KIM, Gyeonggi-do (KR); Geun-Hee YANG, Gyeonggi-do (KR); Donghoon KIM, Gyeonggi-do (KR)

(21) Appl. No.: 18/933,385

(22) Filed: Oct. 31, 2024

Related U.S. Application Data
(60) Provisional application No. 63/656,777, filed on Jun. 6, 2024.

(51) Int. Cl. G06T 7/12; G06T 3/18; G06T 5/20; G06T 7/20; G06V 10/771

(52) U.S. Cl. CPC G06T 7/12; G06T 3/18; G06T 5/20; G06T 7/20; G06V 10/771

(57) ABSTRACT

A method and device are provided in which a video stream is captured by a user equipment (UE). A semantic segmentation network in a processor of the UE generates a first feature map based on a first frame the video stream. The first feature map includes first information for generating a first segmentation and confidence map for the first frame. The processor generates a second feature map for a second frame of the video stream based on the first feature map. The second feature map includes second information for generating a second segmentation and confidence map for the second frame. The processor generates the second segmentation and confidence map based on the second information.

### CROSS-REFERENCE TO RELATED APPLICATION

This application claims the priority benefit under 35 U.S.C. § 119 (e) of U.S. Provisional Application No. 63/656,777, filed on Jun. 6, 2024, the disclosure of which is incorporated by reference in its entirety as if fully set forth herein.

### TECHNICAL FIELD

The disclosure generally relates to image signal processing in wireless devices. More particularly, the subject matter disclosed herein relates to content-aware image signal processing in wireless communication devices.

### SUMMARY

With the existing number of powerful image signal processors (ISPs) in smartphones, comes the need to leverage these ISPs to capture media that best replicates what users see with the highest level of fidelity. These ISPs circumvent constraints set forth by the size and quality of the camera sensor through multiple enhancement algorithms applied on both photos and videos before displaying them to the user. Such algorithms may include noise reduction and color correction algorithms, which do not necessarily capture all that humans are capable of seeing. Accordingly, the media may require enhancement during and post capture in order to closely resemble what the user sees.

Such enhancements may be achieved through per pixel enhancement, which is based on a knowledge of the objects/content in the scene. Knowledge of the objects/content in the scene allows for the use of localized image processing algorithms that may be applied on pixels belonging to a particular object. Specifically, per pixel enhancement of video streams allows for high quality video capture, which closely mimics what humans see. Additionally, the enhancement is applied during the preview, and not offline, in order to show users what the saved media is going to look like.

A segmentation map tightly coupled with the ISP pipeline may lead to higher quality videos and images. One issue with the above approach is that most segmentation models are heavily based on the use of a neural network, do not account for power and run-time constraints, and thus, are not designed for resource-scarce devices.

To overcome these issues, systems and methods are described herein for a video semantic segmentation pipeline for content-aware enhancement in modern ISPs. This pipeline generates per-frame per-pixel semantic segmentation maps based on content of the scene for real-time enhancement of the video stream.

The above approaches improve on previous methods because high quality video may be generated in real-time without the need for further processing, with improved temporal consistency, and reduced power consumption.

In an embodiment, a method is provided in which a video stream is captured by a user equipment (UE). A semantic segmentation network in a processor of the UE generates a first feature map based on a first frame the video stream. The first feature map includes first information for generating a first segmentation and confidence map for the first frame. The processor generates a second feature map for a second frame of the video stream based on the first feature map. The second feature map includes second information for generating a second segmentation and confidence map for the second frame. The processor generates the second segmentation and confidence map based on the second information.

In an embodiment, a method is provided in which a video stream is captured by a UE. A semantic segmentation network in a processor of the UE generates a first feature map based on a first frame of the video stream. The first feature map includes first information for generating a first segmentation and confidence map for the first frame. An infinite impulse response (IIR) filter of the processor generates a corrected feature map based on the first feature map and corrected feature map information of a previous frame of the video stream. The processor generates the first segmentation and confidence map based on the corrected feature map.

In an embodiment, a UE is provided that includes a processor and a non-transitory computer readable storage medium storing instructions. When executed, the instructions cause the processor to capture a video stream, and generate, by a semantic segmentation network, a first feature map based on a first frame of the video stream. The first feature map includes first information for generating a first segmentation and confidence map for the first frame. The instructions also cause the processor to generate a second feature map for a second frame of the video stream based on the first feature map. The second feature map includes second information for generating a second segmentation and confidence map for the second frame. The instructions further cause the processor to generate the second segmentation and confidence map based on the second information.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating a communication system;

FIG. 2 is a diagram illustrating content-aware image signal processing;

FIG. 3 is a diagram illustrating per frame segmentation-confidence map generation;

FIG. 4 is a diagram illustrating a first stage of a video semantic segmentation pipeline, according to an embodiment;

FIG. 5 is a diagram illustrating a first stage of a video semantic segmentation pipeline, according to another embodiment;

FIG. 6 is a diagram illustrating a second stage of a video semantic segmentation pipeline, according to an embodiment;

FIG. 7 is a flowchart illustrating a method for generating enhanced frames of a video stream, according to an embodiment; and

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

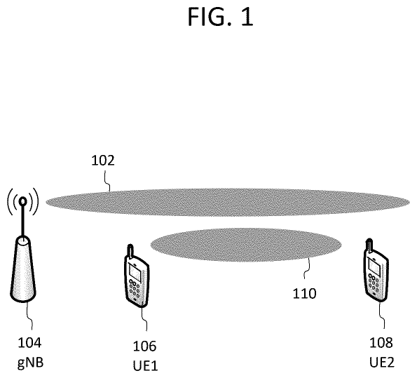

FIG. 1 is a diagram illustrating a communication system, according to an embodiment. In the architecture illustrated in FIG. 1, a first path 102 may enable the transmission of information through a network established between a base station, access point (AP), or a gNode B (gNB) 104, a first UE 106, and a second UE 108. A second path 110 may enable the transmission of data (and some control information) between the first UE 106 and the second UE 108. The first path 102 and the second path 110 may be on the same frequency or may be on different frequencies.

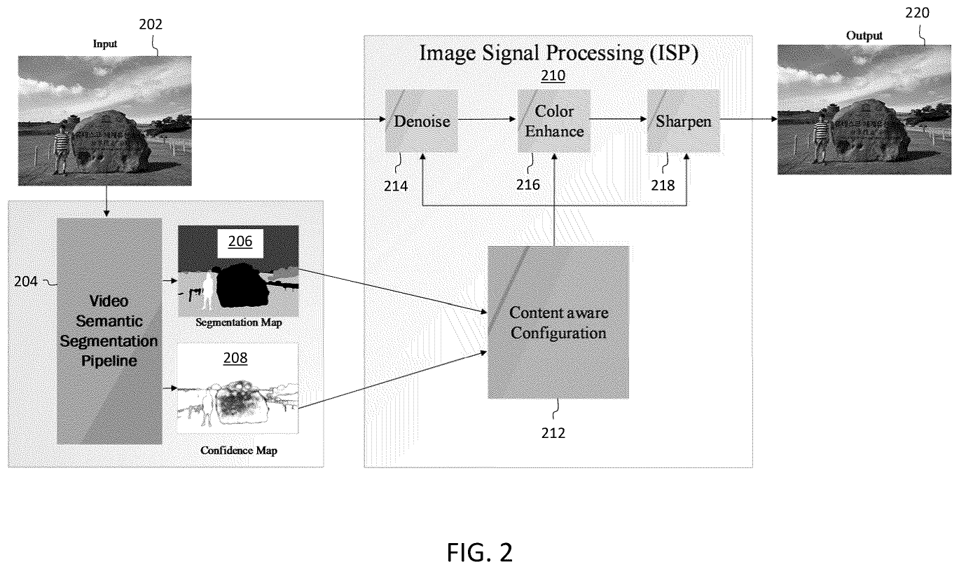

FIG. 2 is a diagram illustrating content aware image signal processing. An input image 202 may be captured by a mobile communication device for image signal processing. The input image 202 is provided to a video semantic segmentation pipeline 204, which generates a segmentation map 206 and a confidence map 208, which may also be embodied as a segmentation-confidence map.

The segmentation-confidence map is a combined map that may be used for image enhancement. The map may provide segmentation and confidence information of every pixel in a frame. The segmentation map may specify the type of object/texture that a particular pixel belongs to, and the confidence map may specify the confidence with which the pixel belongs to a particular object/texture. The segmentation map may be generated by using a neural network.

Referring back to FIG. 2, the segmentation map 206 and the confidence map 208 may be provided to a content-aware configuration module 212 of an ISP 210. Output from the content-aware configuration module 212 may be provided to a denoise module 214, a color enhancement module 216, and a sharpening module 218 along with the input image 202 in the ISP 210. Processing in the ISP 210 may result in an enhanced output image 220.

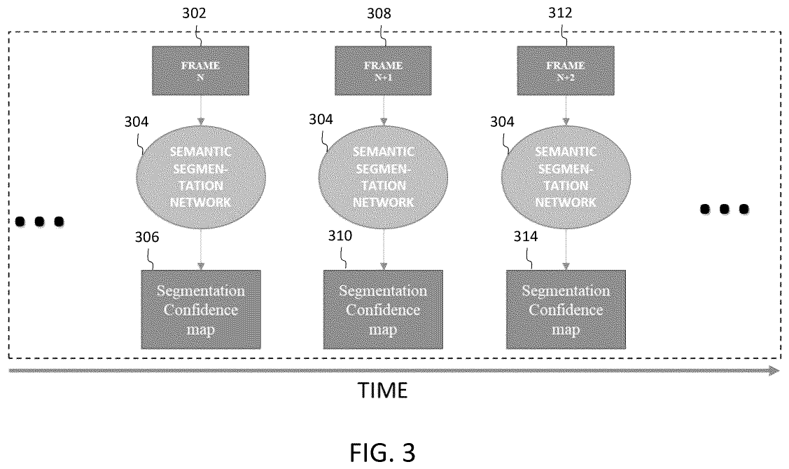

FIG. 3 is a diagram illustrating per frame segmentation-confidence map generation. A first frame (frame N) 302 may be provided to a semantic segmentation network (e.g., neural network) 304 resulting in a first segmentation-confidence map 306. The first frame 302 corresponds to the input image 202 of FIG. 2, and the semantic segmentation network 304 corresponds to the video semantic segmentation pipeline 204 of FIG. 2. Subsequently in time, a second frame (frame N+1) 308 may be provided to the semantic segmentation network 304 resulting in a second segmentation-confidence map 310. A third frame (frame N+2) 312 may then be provided to the semantic segmentation network 304 resulting in a third segmentation-confidence map 314.

According to an embodiment, a video semantic segmentation pipeline may include two stages in generating the segmentation-confidence map, and in which the order of operations is described on a per-frame basis. The first stage may involve generating the segmentation-confidence map. In order to facilitate the use of a same neural network at different resolutions and frame rates, a second stage may correct raw output (e.g., a feature map or logits) from the neural network by applying necessary temporal and spatial algorithms.

The temporal algorithms may include the use of motion vectors/dense optical flow to improve the temporal consistency of the frame, and the use of an IIR filter, which keeps track of the history of predictions made by the network. The temporally corrected feature map may be processed by reshaping them into a desired size and generating a segmentation-confidence map. The spatial algorithm may implement bilinear up-sampling.

The generated map may be used for enhancement in the ISP. For example, some objects (e.g., trees and leaves) may be sharpened and other objects (e.g., faces) may be smoothened using the segmentation and confidence information.

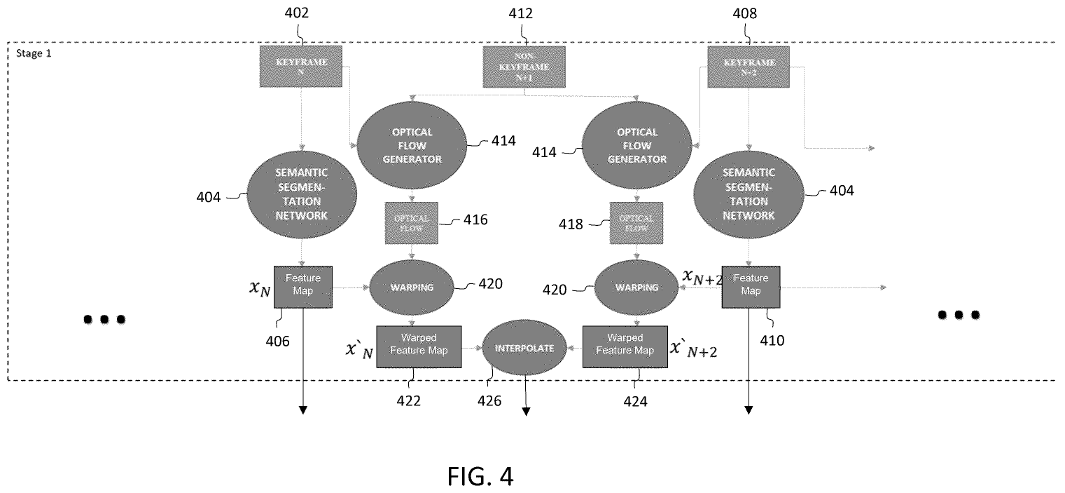

FIG. 4 is a diagram illustrating a first stage of a video semantic segmentation pipeline, according to an embodiment. As described above, the first stage may generate a feature map (e.g., raw data from a neural network) that is passed on to the second stage. A feature map may include all information necessary to generate segmentation and confidence maps.

An incoming frame from a video stream may first be determined as a keyframe or non-keyframe. A keyframe may be defined as a frame for which the neural network is to be utilized. Keyframes may be selected at a fixed frequency or may be dynamically determined based on an amount of motion between frames in the video stream.

A first keyframe (N) 402 entering the pipeline may first be passed through a semantic segmentation network (e.g., neural network) 404. The semantic segmentation network 404 may generate 3-dimensional (3D) output of size U×V×C, where U×V are the spatial dimensions of the feature map, and C is the number of classes the network is trained to detect. Each element in the 2-dimensional (2D) map may correspond to an un-normalized confidence that that a pixel belongs to one of the C classes. The resulting first feature map (x_{N}) 406 may be passed onto the second stage, as described in greater detail below.

Similarly, a second keyframe (N+2) 408 may be passed through the semantic segmentation network 404, which generates a second feature map (x_{N+2}) 410 that may be passed onto the second stage.

For a non-keyframe (N+1) 412 received in time between the keyframes 402 and 408, the pipeline may save power and runtime by skipping the semantic segmentation network 404. This may be achieved by taking advantage of the temporal continuity between frames. An optical flow generator 414 may generate a first optical flow 416 capable of describing inter-frame motion based on the first keyframe 402 and the non-keyframe 412. The optical flow generator 414 may also generate a second optical flow 418 capable of describing inter-frame motion based on the non-keyframe 412 and the second keyframe 408. Optical flows may be defined as spatial maps of dimension H×W×2, where H×W is the height and width of the frame, and each of the two channels (last dimension) corresponds to motion in the horizontal (x-axis) and vertical (y-axis) direction for every pixel. Most mobile ISPs have means to generate the optical flow between consecutive frames.

The first optical flow 416 may be used to warp the first feature map 406 generated by the network 404 from the first keyframe 402, at a warping module 420, resulting in a first warped feature map (x′_{N}) 422. The second optical flow 418 may be used to warp the second feature map 410 generated by the network 404 from the second keyframe 408, at the warping module 420, resulting in a second warped feature map (x′_{N+2}) 424. On most mobile platforms, warping is relatively inexpensive when compared to running a neural network.

By reusing the keyframe's feature maps 406 and 410, the temporal consistency of predictions may be improved, making it less susceptible to noisy input. The method described above may be run in real-time.

For ISPs that can tolerate frame delays, the temporal consistency of the segmentation maps may be improved by a combination of warping and bilinear interpolation. Specifically, the feature map 406 from the most recent keyframe (N) 402 and the feature map 410 from an immediate next future keyframe (N+2) 408 may be warped to the warped feature maps 422 and 424 of an intermediate non-keyframe, as described above. The warped feature maps 422 and 424 may then be interpolated based on the temporal distance between the two keyframes 402 and 408, at an interpolate module 426. The resulting interpolation may be passed on to the second stage as the feature map of the non-keyframe 412. While any interpolation method may be used subject to runtime and quality constraints, a bilinear interpolation is shown in Equation (1) below:

$${x}_{n} = \frac{k 2 - n}{k 2 - k 1} {x}_{k 1}^{′} + \frac{n - k 1}{k 2 - k 1} {x}_{k 2}^{′} \qquad ( 1 )$$

where, x′ₖ₁ and x′ₖ₂ are feature maps 406 and 410 from keyframes k1 402 and k2 408 that are warped to frame n, and where k1<n<k2 and xₙ is the feature map passed on to the second stage from frame n. Frame delay may be introduced due to the nature of the algorithm that relies on subsequent frames for processing the current frame. Specifically, a feature map of a future keyframe may be required to generate a feature map for a current non-keyframe.

As an alternative, for ISPs that cannot tolerate frame delay, a non-keyframe feature map may be generated with warping without interpolation. Specifically, the first optical flow 416 may be reused to warp the first feature map (x_{N}) 406 generated by the network 404 from the first keyframe 402, at the warping module 420, resulting in the first warped feature map (x′_{N}) 422. The first warped feature map 422 may then be passed to the second stage as the feature map from the non-keyframe 412. Accordingly, the optical flow generation and warping are only performed with respect to an immediately previous keyframe, and not a subsequent keyframe, for a given non-keyframe.

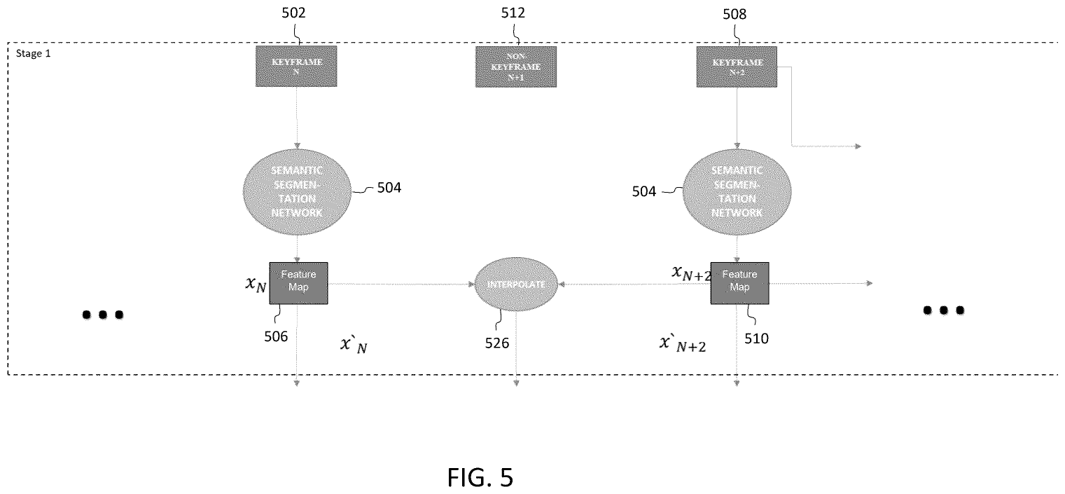

FIG. 5 is a diagram illustrating a first stage of a video semantic segmentation pipeline, according to another embodiment. If good quality optical flow is not available or a warp operation is too expensive, the output of two keyframes may be directly interpolated for improvement in temporal consistency.

As shown in FIG. 5, a first keyframe (N) 502 entering the pipeline may be passed through a semantic segmentation network 504 to generate a first feature map (x_{N}) 506, as described above with respect to FIG. 4. Similarly, a second keyframe (N+2) 508 may be passed through the semantic segmentation network 504 to generate a second feature map (x_{N+2}) 510. The first feature map 506 and the second feature map 510 may be provided to an interpolation module 526 for generation of an interpolated feature map for a non-keyframe (N+1) 512 between the first keyframe 502 and the second keyframe 508. The first feature map 506, the second feature map 510, and the interpolated feature map may be passed onto the second stage, as described in greater detail below.

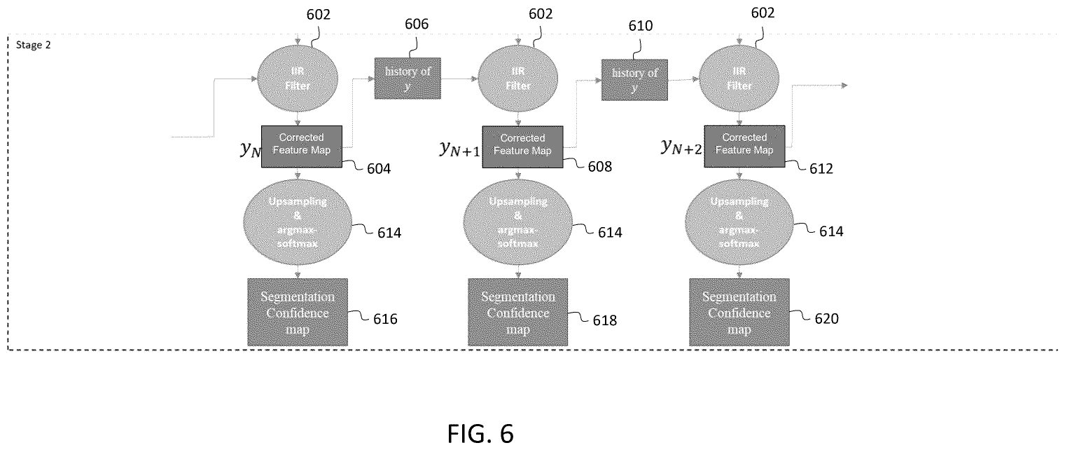

FIG. 6 is a diagram illustrating a second stage of a video semantic segmentation pipeline, according to an embodiment. The second stage may receive the feature maps generated in the first stage as described above with respect to FIGS. 4 and 5. A received feature map for a first frame may first be passed through an IIR filter 602, which further improves the robustness to noisy input resulting in a first corrected feature map (y_{N}) 604. The IIR filter 602 may be in the form of Equation (2) below:

$$y [ n ] = {a}_{0} x [ n ] + {a}_{1} y [ n - 1 ] + {a}_{2} y [ n - 2 ] … \qquad ( 2 )$$

where y corresponds to the output 604 of the IIR filter 602, x corresponds to the current input, and n corresponds to the frame number.

By using the IIR filter 602, the temporal consistency of the output 604 may be improved because a corrected feature map from the past is taken into account. For example, the first corrected feature map 604 may be provided to the IIR filter 602 as history information 606 for processing the feature map of a next frame in the IIR filter 602, resulting in a second corrected feature map (y_{N+1}) 608. Similarly, the second corrected feature map 608 may be provided to the IIR filter 602 as history information 610 for processing the feature map of a subsequent frame in the IIR filter 602, resulting in a third corrected feature map (y_{N+2}) 612.

The first corrected feature map 604 may be up-sampled to a desired size at an up-sampling and argmax-softmax module 614, and a first segmentation-confidence map 616 may be extracted. Similarly, the second corrected feature map 608 and the third corrected feature map 612 may be up-sampled at the up-sampling and argmax-softmax module 614, resulting in a second segmentation-confidence map 618 and a third segmentation-confidence map 620, respectively. There are various algorithms for up-sampling with varying levels of complexity. The confidence information may be extracted through a softmax function given by Equation (3) below:

$$σ ( {y}_{i} ) = \frac{{e}^{{y}_{i}}}{{\sum }_{j = 1}^{C} {e}^{{y}_{j}}} for i = 1 , … , C and {y}_{i} ∈ y \qquad ( 3 )$$

The segmentation class may be given by the argmax (yᵢ∈y) and the confidence value may be obtained by max(σ(yᵢ), yᵢ∈y).

Accordingly, embodiments provide an end-to-end real-time system that generates segmentation and confidence maps for video streams on mobile platforms. A post-processing stage may utilize both optical flow and temporal filtering to reduce power consumption and improve temporal consistency in video semantic segmentation.

In designing for real-time applications, users may view the exact video stream that is being recorded on a preview feed. High quality video may be generated in real-time without the need for further processing.

While neural networks have the ability to learn complex tasks, they are still prone to large fluctuations in the output resulting from small fluctuations in the input. The second stage may ameliorate these issues by using the history of neural network output to improve temporal consistency.

Power consumption may be reduced by using optical flow to generate the segmentation information. This may reduce the dependency on the neural network and takes advantage of the temporal dependency between consecutive frames.

The inherent design of the pipeline allows for parallel execution of the first and second stages, which may support higher frame rates.

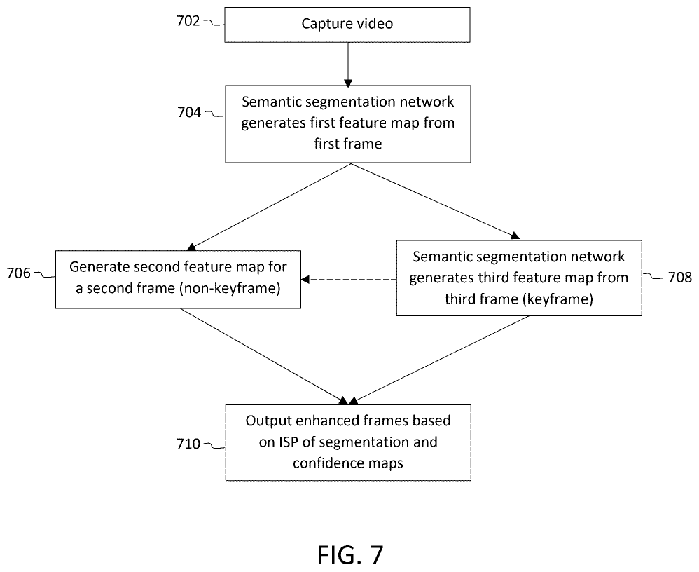

FIG. 7 is a flowchart illustrating a method for generating enhanced frames of a video stream, according to an embodiment. At 702, a UE may capture a video stream. At 704, a semantic segmentation network in a processor of the UE may generate a first feature map based on a first frame (keyframe) of the video stream. The first feature map may include information for generating a first segmentation and confidence map for the first frame.

At 706, the processor may generate a second feature map for a second frame (non-keyframe) of the video stream based at least on the first feature map. The second feature map may include second information for generating a second segmentation and confidence map for the second frame. The second feature map may be generated by generating a first optical flow based on the first frame and the second frame, and warping the first feature map based on the first optical flow.

At 708, the semantic segmentation network may generates a third feature map based on a third frame of the video stream. The third feature map may include third information for generating a third segmentation and confidence map for the third frame. When generation of the second feature map is also based on the third feature map, the operations of 706 and 708 may occur simultaneously, or the operation of 708 may be completed before the operation of 706.

For example, the second feature map may be generated by interpolating the first feature map and the third feature map. The second feature map may also be generated by generating a first optical flow based on the first frame and the second frame, warping the first feature map based on the first optical flow to generate a first warped feature map, generating a second optical flow based on the second frame and the third frame, warping the third feature map based on the second optical flow to generate a second warped feature map, and interpolating the first warped feature map and the second warped feature map to generate the second feature map.

At 710, the UE outputs enhanced frames of the video stream based on image signal processing using respective segmentation and confidence maps. An IIR filter of the processor may generate a corrected feature map based on information on a corrected feature map of a previous frame, and the segmentation and confidence map may be generated by up-sampling the corrected feature map.

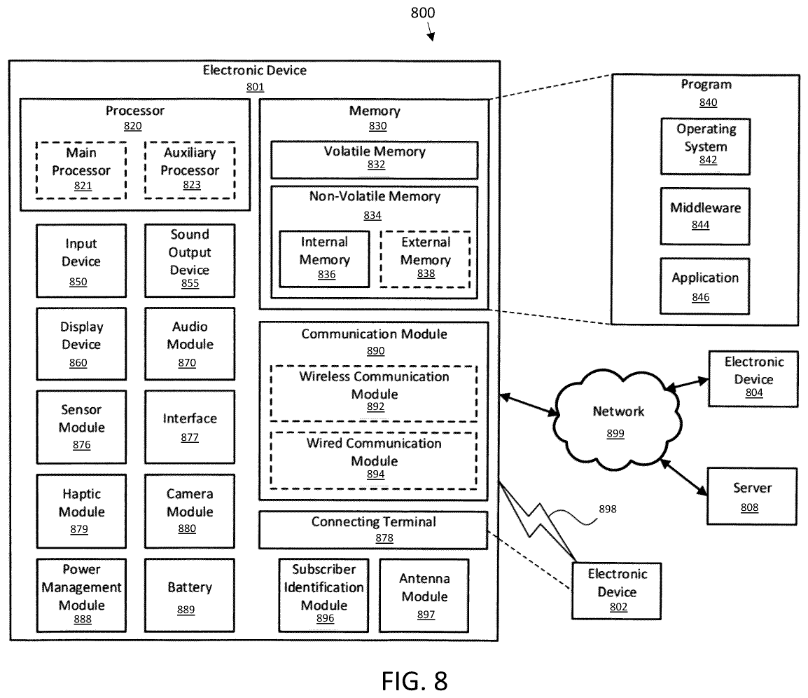

FIG. 8 is a block diagram of an electronic device in a network environment 800, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
capturing a video stream by a user equipment (UE);
generating, by a semantic segmentation network in a processor of the UE, a first feature map based on a first frame of the video stream, wherein the first feature map comprises first information for generating a first segmentation and confidence map for the first frame;
generating, by the processor, a second feature map for a second frame of the video stream based on the first feature map, wherein the second feature map comprises second information for generating a second segmentation and confidence map for the second frame; and
generating, by the processor, the second segmentation and confidence map based on the second information.

2. The method of claim 1, wherein generating the second feature map comprises:
generating, by the processor, a first optical flow based on the first frame and the second frame; and
warping, by the processor, the first feature map based on the first optical flow to generate the second feature map.

3. The method of claim 1, further comprising:
generating, by the semantic segmentation network, a third feature map based on a third frame of the video stream, wherein the third feature map comprises third information for generating a third segmentation and confidence map for the third frame.

4. The method of claim 3, wherein generating the second feature map comprises:
interpolating, by the processor, the first feature map and the third feature map to generate the second feature map.

5. The method of claim 3, wherein generating the second feature map comprises:
generating, by the processor, a first optical flow based on the first frame and the second frame;
warping, by the processor, the first feature map based on the first optical flow to generate a first warped feature map;
generating, by the processor, a second optical flow based on the second frame and the third frame;
warping, by the processor, the third feature map based on the second optical flow to generate a second warped feature map; and
interpolating, by the processor, the first warped feature map and the second warped feature map to generate the second feature map.

6. The method of claim 1, further comprising:
generating, by the processor, an enhanced second frame by image signal processing the second frame based on the second segmentation and confidence map.

7. The method of claim 1, wherein generating the second segmentation and confidence map comprises:
generating, by an infinite impulse response (IIR) filter of the processor, a corrected feature map based on the second feature map and information on the first feature map corrected by the IIR filter; and
generating, by the processor, the second segmentation and confidence map based on the corrected feature map.

8. The method of claim 7, wherein the second segmentation and confidence map is generated by up-sampling the corrected feature map.

9. A method comprising:
capturing a video stream by a user equipment (UE);
generating, by a semantic segmentation network in a processor of the UE, a first feature map based on a first frame of the video stream, wherein the first feature map comprises first information for generating a first segmentation and confidence map for the first frame;
generating, by an infinite impulse response (IIR) filter of the processor, a corrected feature map based on the first feature map and corrected feature map information of a previous frame of the video stream; and
generating, by the processor, the first segmentation and confidence map based on the corrected feature map.

10. The method of claim 9, further comprising:
generating, by the processor, an enhanced first frame by image signal processing the first frame based on the first segmentation and confidence map.

11. The method of claim 9, wherein the first segmentation and confidence map is generated by up-sampling the corrected feature map.

12. The method of claim 9, further comprising:
generating, by the processor, a first optical flow based on the first frame and a second frame of the video stream; and
warping, by the processor, the first feature map based on the first optical flow to generate a second feature map for the second frame, wherein the second feature map comprises second information for generating a second segmentation and confidence map for the second frame.

13. The method of claim 9, further comprising:
generating, by the semantic segmentation network, a second feature map based on a second frame of the video stream, wherein the second feature map comprises second information for generating a second segmentation and confidence map for the second frame; and
generating, by the processor, a third feature map for a third frame of the video stream based on the first feature map and the second feature map, wherein the third feature map comprises third information for generating a third segmentation and confidence map for the third frame.

14. The method of claim 13, wherein generating the third feature map comprises interpolating the first feature map and the second feature map to generate the third feature map.

15. The method of claim 13, wherein generating the third feature map comprises:
generating, by the processor, a first optical flow based on the first frame and the third frame;
warping, by the processor, the first feature map based on the first optical flow to generate a first warped feature map;
generating, by the processor, a second optical flow based on the second frame and the third frame;
warping, by the processor, the second feature map based on the second optical flow to generate a second warped feature map; and
interpolating, by the processor, the first warped feature map and the second warped feature map to generate the a third feature map.

16. A user equipment (UE) comprising:
a processor; and
a non-transitory computer readable storage medium storing instructions that, when executed, cause the processor to:
capture a video stream;
generate, by a semantic segmentation network, a first feature map based on a first frame of the video stream, wherein the first feature map comprises first information for generating a first segmentation and confidence map for the first frame;
generate a second feature map for a second frame of the video stream based on the first feature map, wherein the second feature map comprises second information for generating a second segmentation and confidence map for the second frame; and
generate the second segmentation and confidence map based on the second information.

17. The UE of claim 16, wherein, in generating the second feature map, the instructions further cause the processor to:
generate a first optical flow based on the first frame and the second frame; and
warp the first feature map based on the first optical flow to generate the second feature map.

18. The UE of claim 16, wherein:
the instructions further cause the processor to generate, by the semantic segmentation network, a third feature map based on a third frame of the video stream, wherein the third feature map comprises third information for generating third segmentation and confidence maps for the third frame; and
in generating the second feature map, the instructions further cause the processor to interpolate the first feature map and the third feature map to generate the second feature map.

19. The UE of claim 16, wherein:
the instructions further cause the processor to generate, by the semantic segmentation network, a third feature map based on a third frame of the video stream, wherein the third feature map comprises third information for generating a third segmentation and confidence map for the third frame; and
in generating the second feature map, the instructions further cause the processor to:
generate a first optical flow based on the first frame and the second frame;
warp the first feature map based on the first optical flow to generate a first warped feature map;
generate a second optical flow based on the second frame and the third frame;
warp the third feature map based on the second optical flow to generate a second warped feature map; and
interpolate the first warped feature map and the second warped feature map to generate the second feature map.

20. The UE of claim 16, wherein the instructions further cause the processor to:
generate, by an infinite impulse response (IIR) filter, a corrected feature map based on the second feature map and information on the first feature map corrected by the IIR filter, wherein the second segmentation and confidence map is generated by upscaling the corrected feature map; and
generate an enhanced second frame by image signal processing the second frame based on the second segmentation and confidence map.
